(19) United States
(12) Patent Application Publication
(10) Pub. No.: US 2017/0041557 A1
(43) Pub. Date: Feb. 9, 2017

(54) GENERATION OF DATA-ENRICHED VIDEO FEEDS

(71) Applicant: DataFoxTrot, LLC, Albany, NY (US)

(72) Inventors: Karl Andrew Urich, Albany, NY (US); Linda-Lee Navarette, Troy, NY (US)

(21) Appl. No.: 15/228,647

(22) Filed: Aug. 4, 2016

Related U.S. Application Data
(60) Provisional application No. 62/200,765, filed on Aug. 4, 2015.

(51) Int. Cl. H04N 5/272; B64D 47/08; B64C 39/02; G11B 27/036; H04N 7/18

(52) U.S. Cl. CPC H04N 5/272; G11B 27/036; H04N 7/183; B64C 39/024; B64D 47/08

(57) ABSTRACT

Aspects of the present disclosure include a computer-implemented method for generating a data-enriched video feed. The method can include: pairing a camera feed of an aerial vehicle (AV) from a flight session with a telemetry feed of the AV from the flight session; converting a set of pixel coordinates within the camera feed into a first set of geospatial coordinates using the telemetry feed of the AV from the flight session; and rendering a data-enriched video feed including the at least one set of feature data, including a corresponding second set of geospatial coordinates, superimposed onto the first set of geospatial coordinates within the camera feed.

### BACKGROUND

The present disclosure relates generally to systems and methods for generating data-enriched video feeds using accessible geospatial data with archived or real-time video feeds. More specifically, the present disclosure relates to process methodologies for superimposing visual representations of one or more sets of geospatial data onto an archived or real-time video feed, such as those generated by an aerial vehicle (AV) including unmanned aerial vehicles (UAVs), known colloquially as “drones,” to provide enhanced context and additional information to viewers of those video feeds.

Through the increasing availability of networked devices, including personal devices such as computers, cellular phones, tablets, consumers enjoy increased access to public and private sources of information on a variety of topics. Generally, even when these forms of information are presented in a visual format, it can be difficult or seemingly impossible to combine information from disparate sources or in different forms within a unified interface. Some information may be generated personally by a user, or can be generated and/or made available by members of the general public. However generated, this information may overlap meaningfully with a large number of external data sources (e.g., commercially and/or publically available sources of data). User-generated or publically-generated content can include, e.g., camera feeds from an aerial vehicle such as a drone, recording or depicting a particular environment. Although it may be possible to automatically combine data from disparate sources which share particular characteristics, automatic modification of data to be transferred and/or displayed in a different format may be more complex. As a result, one challenge in this field can include combining spatial data, e.g., with an inherent latitude and longitude for various points, with video data which has no inherent or complete set of associated geospatial context.

### SUMMARY

A first aspect of the present disclosure provides a method computer-implemented method for generating a data-enriched video feed, the method including: pairing a camera feed of an aerial vehicle (AV) from a flight session with a telemetry feed of the AV from the flight session; converting a set of pixel coordinates within the camera feed into a first set of geospatial coordinates using the telemetry feed of the AV from the flight session; and rendering a data-enriched video feed including the at least one set of feature data, including a corresponding second set of geospatial coordinates, superimposed onto the first set of geospatial coordinates within the camera feed.

A second aspect of the present disclosure provides a system for generating a data-enriched video feed with an aerial vehicle (AV) the system including: a camera for capturing a camera feed; an adjustable mount operatively coupling the camera to the AV and configured to adjust an angle of the camera relative to a horizontal axis, and an angle of the camera relative to a vertical axis; a telemetry sensor operatively coupled with the AV for generating a telemetry feed including an x-coordinate, a y-coordinate, and a z-component of the AV; and a computing device in communication with a geospatial data repository having at least one set of feature data provided therein, wherein the computing device is configured to: pair the camera feed of the aerial vehicle (AV) from a flight session with the telemetry feed of the AV from the flight session; convert a set of pixel coordinates within the camera feed into a first set of geospatial coordinates using the telemetry feed of the AV from the flight session; render a data-enriched video feed including the at least one set of feature data, including a corresponding second set of geospatial coordinates, superimposed onto the first set of geospatial coordinates within the camera feed.

A third aspect of the present disclosure provides a program product stored on a computer readable storage medium, the program product operable to generate a data-enriched video feed when executed, the computer readable storage medium including program code for: pairing a camera feed of an aerial vehicle (AV) from a flight session with a telemetry feed of the AV from the flight session; converting a set of pixel coordinates within the camera feed into a first set of geospatial coordinates using the telemetry feed of the AV from the flight session; rendering a data-enriched video feed including the at least one set of feature data, including a corresponding second set of geospatial coordinates, superimposed onto the first set of geospatial coordinates within the camera feed.

### BRIEF DESCRIPTION OF THE DRAWINGS

FIG. 1 provides a schematic view of a system according to embodiments of the present disclosure.

FIG. 2 is a photograph depicting an example of a data-enriched video feed according to embodiments of the present disclosure.

FIG. 3 provides a schematic of an illustrative environment for performing a method or operating a system according to embodiments of the present disclosure.

FIG. 4 shows an illustrative flow diagram of sub-processes for generating a data-enriched video feed according to embodiments of the present disclosure.

FIG. 5 shows an alternative flow diagram of processes for generating a data-enriched video feed and identifying items according to embodiments of the present disclosure.

FIG. 6 shows an illustrative flow diagram of processes for generating a data-enriched video feed with additional, optional processes according to embodiments of the present disclosure.

FIG. 7 shows an illustrative flow diagram of processes for generating a data-enriched video feed with a tiered or subscription model according to embodiments of the present disclosure.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

The widespread commercial availability of both aerial vehicles (AVs), such as unmanned aerial vehicles (UAVs), and “smart devices” such as tablets and cellular phones with computing and/or camera systems (including, e.g., conventional and stereoscopic cameras) embedded therein, have contributed to the wide availability of public and premium data sources to consumers. In addition, AVs may be manufactured in a variety of sizes, including “small” and “non-traditionally small” sized AVs, relative to earlier models. Many types of data may be available for viewing and/or purchase over the internet through a wide variety of devices. To increase the applicability and marketability of various forms of data, other technologies may be combined and/or used with raw data to provide an enhanced and more straightforward experience to subscribers, purchasers, or other users of the raw data.

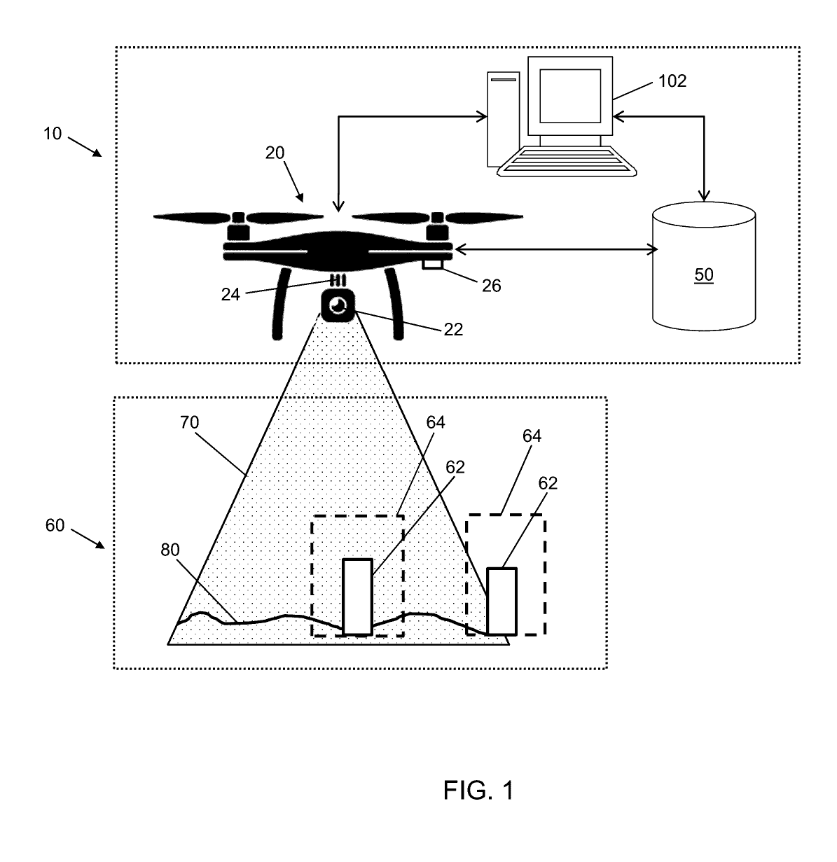

Referring to FIG. 1, a schematic view of a system 10 according to embodiments of the present disclosure is shown. System 10 can include, operate upon, and/or interact with an AV 20 in the form of any device, manned or unmanned, capable of undertaking flight. As examples, AV may be in the form of an airplane, helicopter, gyrocopter, drone, glider, satellite, etc., whether manned (e.g., by an operator positioned therein or by a remote operator), or unmanned (e.g., operated partially or completely automatically by a computer). AV 20 can include or be operatively coupled to a camera system 22 through an adjustable mount 24. In addition, AV 20 can include a telemetry sensor 26 for determining values such as an X, Y, and a Z coordinate of AV 20 expressed in terms of, e.g., latitude, longitude, and height relative to sea level or another reference elevation. Telemetry sensor 26 can also measure, e.g., in vector format, a pitch (i.e., rotation about a vertical axis), roll (i.e., angular orientation of AV 20 above or below a horizontal axis substantially parallel to a side-to-side span or wingspan of AV 20), yaw (i.e., angular orientation of AV 20 to the left or right of a horizontal axis substantially parallel with a nose of AV 20), and/or the position or orientation of camera system 22 relative to horizontal or vertical axes. Telemetry sensor 26 can include and/or otherwise interact with a system for determining the physical location of one or more remote objects. In an example embodiment, telemetry sensor 26 can be provided in the form of a GPS transceiver operably connected to AV 20. AV 20 can include or be in communication with a geospatial data repository 50 for storing, archiving, and/or remotely providing one or more sets of data pertaining to an environment on earth. These types of data, however stored or expressed, are referred to herein as “feature data.” Geospatial data repository 50 can be provided as an integral component of AV 20 or can be provided as an independent component operatively connected to AV 20 and/or a user thereof, e.g., wirelessly through any type of network.

Methods of the present disclosure can process archived and/or real-time pictures and/or videos (referred to collectively herein as a “camera feed”) created, captured, processed, etc., by AV 20 and/or camera system 22. Camera system 22 can, in an embodiment, generate video feeds with pixel coordinate data in only two dimensions of space, even where the camera feed depicts a three-dimensional environment. In other applications, e.g., where camera system 22 is provided in the form of a stereoscopic camera, the coordinate data can be in the form of a vector-format data field which provides pixel coordinate data in three dimensions of space. In some embodiments, camera system 22 can include any currently-known or later developed system for recording audio and/or visual inputs for display on a virtual reality (“VR”) device. Although examples herein refer to camera system 22 or components of AV 20 as capturing one or more camera feeds in real time, it is understood that alternative embodiments can include other devices for mapping and/or assigning pixel coordinates to pre-recorded or archived camera feeds from AV 20. A vector-format data field refers to a single item of data with multiple values contained therein, which can correspond to different coordinates along three axes (X, Y, Z, etc.). Camera system 22, as an alternative to being a sub-system of AV 20, can include or compose a part of a computing device such as a laptop computer, a video camera, a phone, a tablet computer, a personal computer, a wearable or non-wearable computing device, etc. In an embodiment, camera system 22 can include multiple lenses in a stereoscopic arrangement, thereby functioning as a three-dimensional (“3D”) camera capable of recording and/or simulating three-dimensional environments, e.g., by superimposing images from one lens onto another, triangulating the position of pixels or other cross-referenced features of each lens with respect to a shared timeline, and/or other techniques. As used herein, the terms “superimpose,” “superimposition,” and/or variants thereof generally refer to one or more techniques by which two or more items are combined to form a third item. For instance, two images or video recordings can be combined to yield a third image or video recording by superimposing one item of visual and/or other data onto one or more other item of visual and/or other data. The process by which superimposition is implemented can define one or more rules, techniques, decisions, etc., for combining the particular items. For instance, one superimposition technique may use portions of one item to overwrite another to provide the appearance of one item being displayed upon or being placed over the other item. In some situations, items produced by superimposition my include one or more features not directly present in any of the original items, but produced by one or more of the superimposed items having or sharing particular traits. It is also understood that four, six, eight, ten, or any conceivable number of lenses in camera system 22 can be used for mapping pixel coordinates and/or generating multiple camera feeds by camera system 22 sequentially or simultaneously.

Camera system 22 of AV 20 can capture one or more video feeds of an environment 60 during operation. Environment 60 can include multiple items 62 and/or boundaries 64. For example, where environment 60 includes a residential neighborhood, each item 62 can represent a building or group of buildings (e.g., a single home or residential development, landmarks with associated names, natural features, a utility power line, etc.). Each boundary 64 can correspond to, e.g., a property line, a zoning line, a boundary between towns or regions, etc. Boundaries 64, in some cases, may not correspond to particular item(s) 62, and may be independent properties of environment 60. Each boundary 64 and each item 62 may or may not be visible or apparent to a human observer or simple camera systems 22, and can be definable within geospatial data repository 50 as a type of feature data. Camera system 22 can view items 62 and within a given field of vision 70 during a flight session of AV 20. As used herein, the term “flight session” broadly refers to any instance of time in which one or more AVs 20 move through space by any currently-known or later developed form of movement, e.g., sequentially and/or simultaneously. During a flight session of AV(s) 20, components thereof can automatically or by instruction of a user undertake one or more actions (e.g., recording of audio and visual inputs, providing feedback, interacting with other devices and/or other AVs 20, etc.). A flight session of AV 20(s) can therefore include any movement of AV 20(s) implemented automatically, partially or wholly controlled by a user of AV 20(s), etc. Thus, references to one or more flight sessions of a single AV 20 described herein may also refer to flight sessions of multiple AVs 20.

Only a subset of items 62 and boundaries 64 may be visible within a camera feed generated during a flight session at a particular instance of time, but any conceivable number of items 62 and boundaries 64 can be captured in video feed(s) of AV 20 over the time period of a given flight session. Environment 60 can also include a surface topology 80, which may be generally visible to a human observer or non-data enriched camera feed recorded by camera system 22. Surface topology 80 can generally refer to any representation of surface characteristics within environment 60, including, e.g., flat regions, sloped regions, plateaus, valleys, sheer surfaces, etc. Surface topology 80 within environment 60 can be expressed mathematically, e.g., within feature data of geospatial data repository 50, as mathematical functions relative to a three-dimensional coordinate system. For instance, geospatial data repository 50 can include algorithms, formulas, look-up tables, and/or combinations thereof for determining an X, Y, or Z coordinate based on two coordinates selected from X, Y, or Z, values. The relationship between three-dimensional coordinates, as applicable to environment 60, can be a deterministic expression and/or approximation of surface topology 80. Surface topology 80, however expressed, can be used to calculate the geospatial coordinates of items 62 and/or boundaries 64, e.g., by adjusting pixel locations or a simulated surface on earth using reference positions, known amounts of environmental slope (e.g., increasing and decreasing elevations). In an embodiment, these adjustments based on surface topology 80 can include fundamental and trigonometric calculations and/or combinations and variants thereof.

As discussed in detail elsewhere herein, system 10 can include a computer system 102 in communication with AV 20, camera system 22, adjustable mount 24, and/or geospatial data repository 50. For example, computer system 102 can be embedded within AV 20 as a component thereof, or can be embodied as a remotely located device such as a tablet, PC, smartphone, etc., in communication with AV 20 through any combination of wireless and/or wired communication protocols.

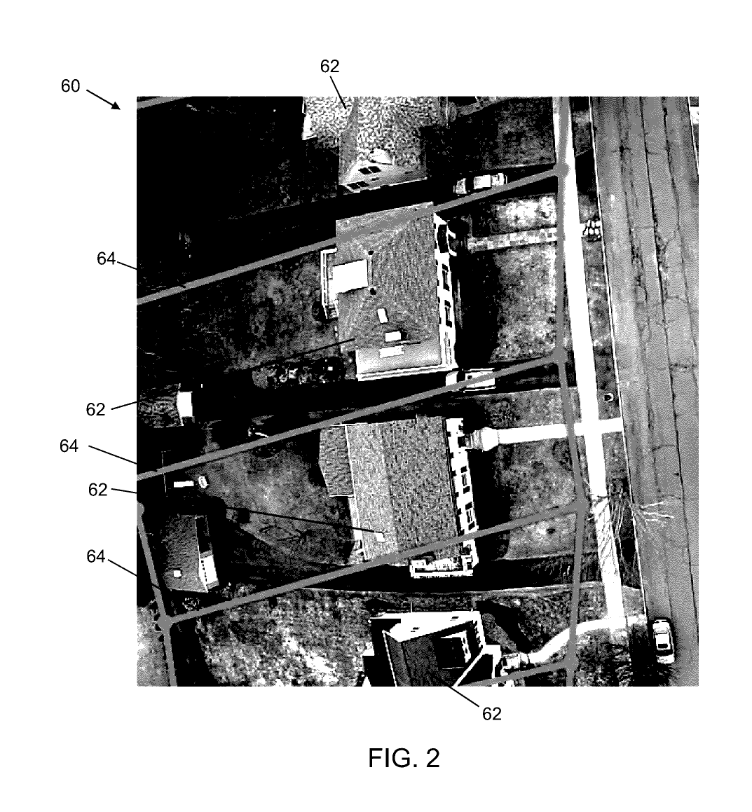

Turning to FIG. 2, an example of a data-enriched video feed according to embodiments of the present disclosure, illustrating environment 60, is shown. Computer system 102 can carry out process steps for combining feature data in geospatial data repository 50 with camera feeds from camera system 22 as described herein. For example, computing system 102 can convert one or more camera feeds from camera system 22, using a telemetry feed of AV 20 from telemetry sensor 26 and feature data in geospatial data repository 50, into one or more data-enriched video feeds including a graphical display or overlay of data from geospatial data repository 50 onto camera feed(s) from camera system 22. Whether camera feeds from camera system 22 are being shown in real time or in a playback mode, computing system 102 of system 10 can automatically superimpose one or more sets of feature data from geospatial data repository 50 onto the camera feed(s) to illustrate the position of item(s) 62 and boundaries 64 in environment 60. That is, the superimposed illustrations of feature data from geospatial data repository 50 can be rendered as time and position-dependent illustrations which translate through field of vision 70 of the camera feed automatically as the camera feed moves to different locations. In an embodiment, system 10 can function as an augmented reality system by which a user of an AV 20, including camera system 22, can automatically view feature data from geospatial data repository 50 superimposed onto camera feeds captured in real time, during a flight session.

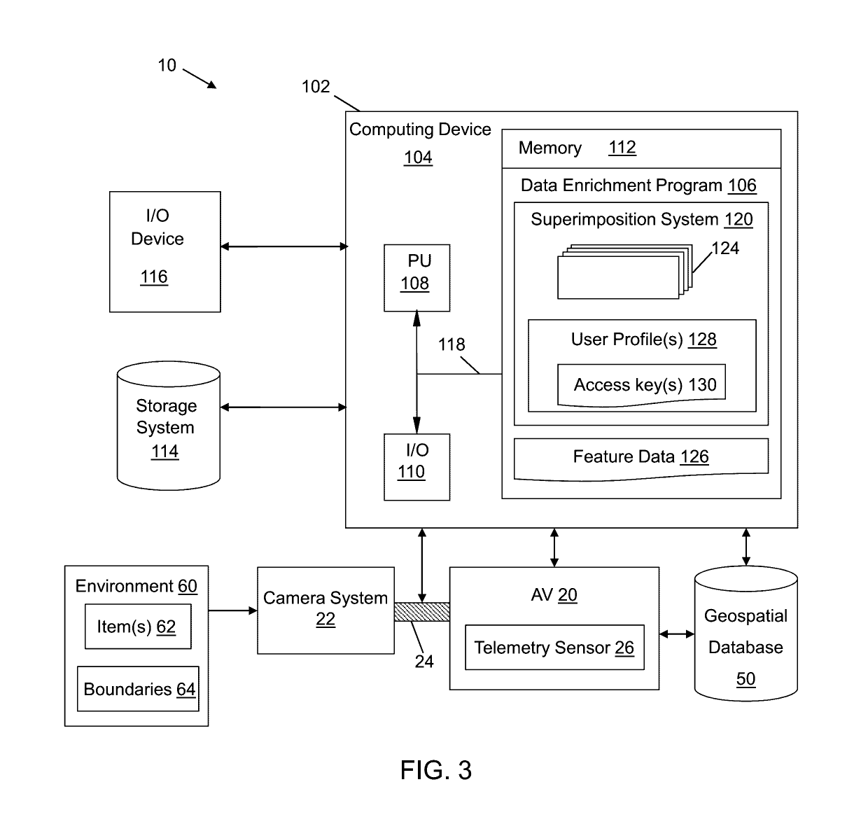

Turning to FIG. 3, a schematic view of an illustrative environment including system 10 according to embodiments of the present disclosure is shown. Computer system 102 can be in communication with AV 20 and camera system 22, operably connected to each other through adjustable mount 24. Computer system 102 can include hardware and/or software for carrying out process steps discussed herein for processing one or more camera feeds stored locally or received from another system, e.g., from camera system 22 of AV 20. Computer system 102 can capture and/or archive a camera feed of environment 60, identify items 62 and/or boundaries 64, estimate the position of items 62 and/or boundaries 64 using telemetry sensor 26, and generate a data-enriched video feed. It is understood that embodiments of the present disclosure can apply multiple approaches for determining the pixel coordinates of any item 62 that has a latitude and longitude, or pixel coordinates for any boundary 64 that has a set of longitude and latitude pairs. Example techniques for determining pixel coordinates are expressed in detail elsewhere herein. The data-enriched video feed can include the camera feed from camera system 22 and superimposed data, e.g., from geospatial data repository 50. Throughout the processes described herein and/or other related processes, computer system 102 assigns two-dimensional and/or three-dimensional coordinates to the camera feed(s), and items 62 and boundaries 64 therein, using a telemetry feed from telemetry sensor 26 to superimpose feature data thereon. Computer system 102 can be communicatively coupled to camera system 22 to send and receive a camera feed therefrom. Computer system 102 can more particularly receive output data from camera system 22, e.g., as archived outputs or a real time output, and perform method steps and/or processes described in detail herein. Computer system 102 can interact with camera system 22 and/or other devices which include camera feeds, which can coincide with one or more items 62 and/or boundaries 64.

Computer system 102 can include a computing device 104, which in turn can include a data enrichment program 106. The components shown in FIG. 3 are one embodiment of system 10 (FIG. 1) for generating a data-enriched video feed. As discussed herein, computing device 104 can output a data-enriched video feed which includes camera feed(s) from camera system 22 and one or more sets of feature data superimposed thereon, based on geospatial coordinates calculated for one or more camera feeds produced with camera system 22, e.g., during a flight session of AV 20. Embodiments of the present disclosure may be configured or operated in part by a technician, computing device 104, and/or a combination of a technician and computing device 104. It is understood that some of the various components shown in FIG. 3 can be implemented independently, combined, and/or stored in memory for one or more separate computing devices that are included in computing device 104. Further, it is understood that some of the components and/or functionality may not be implemented, or additional schemas and/or functionality may be included as part of data enrichment program 106.

Computing device 104 can include a processor unit (PU) 108, an input/output (I/O) interface 110, a memory 112, and a bus 118. Further, computing device 104 is shown in communication with an external I/O device 116 and a storage system 114. Data enrichment program 106 can execute superimposition program 120, which in turn can include various software components, including modules 124, configured to perform different actions. The various modules 124 of superimposition program 120 can use algorithm-based calculations, look up tables, and similar tools stored in memory 112 for processing, analyzing, and operating on data to perform their respective functions. In general, PU 108 can execute computer program code to run software, such as superimposition program 120, which can be stored in memory 112 and/or storage system 114. While executing computer program code, PU 108 can read and/or write data to or from memory 112, storage system 114, and/or I/O interface 110. Bus 118 can provide a communications link between each of the components in computing device 104. I/O device 116 can comprise any device that enables a user to interact with computing device 104 or any device that enables computing device 104 to communicate with the equipment described herein and/or other computing devices. I/O device 116 (including but not limited to keyboards, displays, pointing devices, etc.) can be coupled to computer system 102 either directly or through intervening I/O controllers (not shown).

Memory 112 can also include a copied, viewed, indexed, locally saved version, and/or paired version of feature data 126 obtained from geospatial data repository 50. Feature data 126 can pertain to one or more environments 60 wholly or partially depicted in camera feed(s) of camera system 22. Superimposition system 120 of computing device 104 can store and interact with feature data 126 in processes of the present disclosure. For example, memory 112 can temporarily or permanently store feature data 126 received from geospatial data repository 50 (whether provided locally in computing device 104 or through other devices), which can be examined, processed, modified, etc. with computing device 104 according to embodiments of the present disclosure. Feature data 126 can include a catalogue, inventory, or similar listing of item(s) 62 and/or boundaries 64 with corresponding geospatial coordinates, whether absent from, partially within, or wholly within environment(s) 60 perceived with camera system 22 during one or more flight sessions. Modules 124 can process camera feeds from camera system 22 to convert pixel coordinates into geospatial coordinates, e.g., using a feed from telemetry sensor 26, and identify and/or estimate the position of items 62 and/or boundaries 64 in environment 60 according to method steps discussed herein. Superimposition system 120, specifically, can convert pixel coordinates of camera feeds into geospatial coordinates, upon which feature data 126 with corresponding geospatial coordinates can be superimposed. Superimposition system 120 may be designed to implement one or more of a variety of currently-known or later developed superimposition techniques for varying items. In addition, superimposition system 120 of memory 112 can include a record of one or more user profiles 128 corresponding to registered and/or guest users of data enrichment program 106. Each user profile 128 can include or lack access key(s) 130, which can signify authorization for or prohibition from corresponding types of feature data 126 obtained from geospatial data repository 50. As is discussed elsewhere herein, the characteristics of user profile(s) 128 (e.g., the presence or absence of particular access keys 130) can determine which types of feature data 126 are superimposed onto real-time or archived camera feeds generated with camera system 22. It is also understood that other types of permanent and/or transitory data (e.g. the name of an item 62 and/or boundary 64) may be stored in various fields not mentioned explicitly herein in embodiments of the present disclosure, as may be desired for particular implementations.

As discussed herein, modules 124 can perform various functions to execute method steps according to embodiments of the present disclosure. Some functions of modules 124 are described herein as non-limiting examples. A comparator module can compare two or more mathematical quantities, including values of pixel and geospatial coordinate data. A determinator module can select one of at least two alternative steps or outcomes based on other operations performed by object superimposition system 120 or other pieces of software and/or hardware. A calculator module can perform fundamental or complex mathematical operations. Other modules can perform one or more of the functions described herein as alternatively being performed with other components (e.g., geospatial data repository 50, telemetry sensor 26, etc.) including software to support system(s) 22, telemetry sensor 26, and/or the controllable actions of AV 20 and/or adjustable mount 24. Other modules 124 can be added and/or adapted to perform process steps described herein but not separately discussed.

Computing device 104 can comprise any general purpose computing article of manufacture for executing computer program code installed by a user (e.g., a personal computer, server, handheld device, etc.). However, it is understood that computing device 104 is only representative of various possible equivalent computing devices and/or technicians that may perform the various process steps of the disclosure. In addition, computing device 104 can be part of a larger system architecture for generating data-enriched video feeds.

To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 104 may include a program product stored on a computer readable storage device, which can be operative to automatically generate data-enriched video feeds when executed.

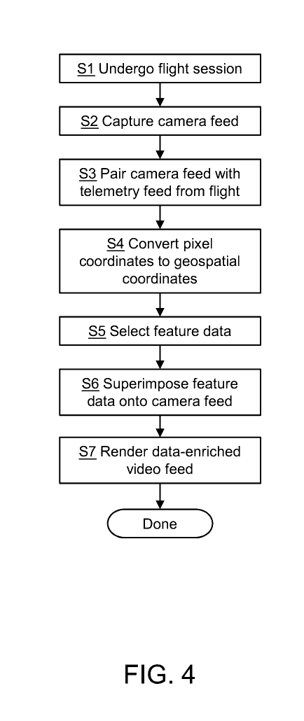

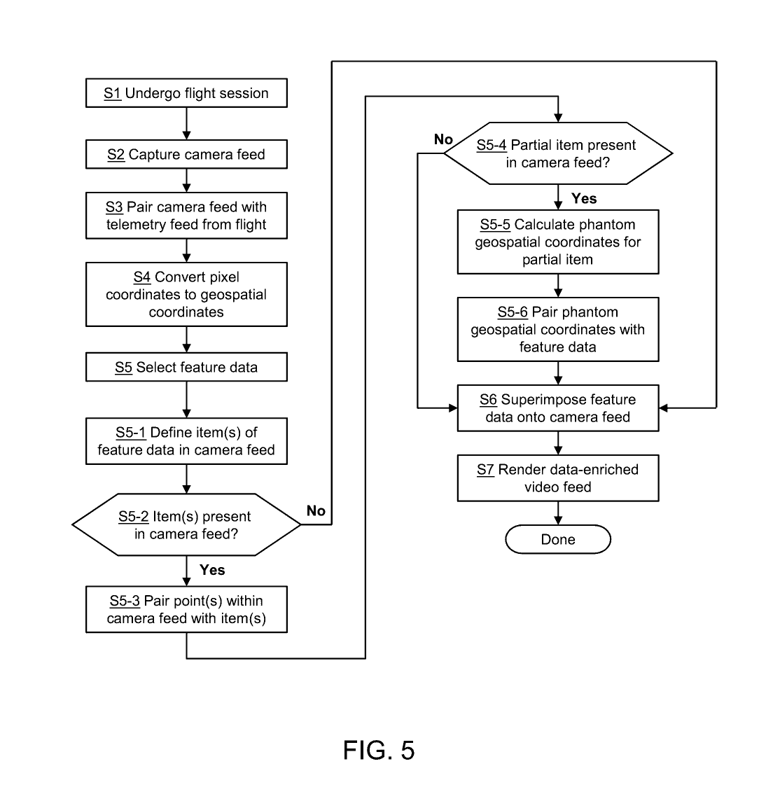

Referring to FIGS. 3 and 4 together, process steps according to embodiments of the present disclosure are discussed. The various process steps discussed herein can be performed via an embodiment of computer system 102 and/or equivalent systems or components. A generalized version of a process methodology for generating a data-enriched video feed is provided in FIG. 4, showing process steps S1-S7. However, as also discussed herein, additional and/or alternative process steps can be applied to provide different functions as shown in FIGS. 5-7 and discussed in detail elsewhere herein. Step S1 can include performing a partial or complete flight session of AV 20, which can occur in real-time or be recorded for archival and future access. The flight session can be implemented, e.g., as a preparatory step before other steps in embodiments of the present disclosure, and/or as a simultaneous step for generating one or more camera feeds upon which feature data can be superimposed to generate a data-enriched video feed. Thus, although step S1 is shown by example as being a first sequential step, it is understood that step S1 can be executed in parallel with other steps according to the present disclosure, and thereby performed on an ongoing basis. Continuing with the process flow, a camera feed can be captured with camera system 22 in step S2 during a particular flight session of step S1, and/or following a different flight session. In an alternative embodiment, step S2 can include starting the operation of camera system 22 part-way through a flight session (e.g., of step S1), such that the camera feed captured in step S2 may be transmitted to a user in real time. Thus, step S2 can be performed simultaneously with or sequentially before other process steps herein, and can be performed as a preliminary or ongoing with other processes discussed herein.

At step S3, one or more camera feeds captured using camera system 22 can be paired with a corresponding telemetry feed of telemetry sensor 26. Specifically, readings from telemetry sensor 26 as a function of time can be paired with instances of one or more camera feeds captured with camera system 22 and corresponding to the same flight sessions and/or instances of time.

Following step S3, the camera feeds paired with a telemetry feed can be expressed only in pixel coordinates, initially without corresponding geospatial coordinates. In step S4, however, modules 124 of superimposition program 120 can convert the pixel coordinates for the camera feed into geospatial coordinates using a feed from telemetry sensor 26. Telemetry sensor 26 can be configured to provide a parametric feed of X, Y, and Z coordinates of AV 20 relative to time, without providing a direct measurement of X, Y, and Z coordinates of environment(s) 60 captured with camera system 22. However, modules 124 can derive actual or approximate coordinate values for environment 60 using measurements from telemetry sensor 26 and/or algorithms, formulas, etc. for converting pixel coordinate data into geospatial coordinate data. One example implementation includes using X, Y, and Z coordinates generated with telemetry sensor 26 to calculate (e.g., by direct measurement and/or derivation from other quantities) a set of angles in between the AV 20 and the earth, referred to herein as “angle values.” The position or orientation of camera system 22 including the angular orientation of AV 20 above or below a horizontal axis can modify the originally calculated angle values. Modules 124 of computing system 102 can automatically calculate and/or modify these angle values, in addition to calculating or recalculating of the locations of items 62 and/or boundaries 64.

In addition, modules 124 can calculate a center point of the video frame and the horizontal, vertical and diagonal extent of the video frame. Regardless of the processes used, each calculation can use any combination of trigonometric operations to calculate angles between points in space and a sphere or substantially spheroidal object. In other embodiments, e.g., where absolute precision is not required or where computing power is not sufficient to process all data, the method could perform all calculations with planar geometry assuming a flat earth surface for surface topology 80. In addition, further corrections for lens distortion, discussed elsewhere herein, can optionally be used based on any precision requirements and performance considerations for a given environment 60 or intended use of an output. It is also understood that the example calculations discussed herein can be performed using polar and/or Cartesian coordinate systems for angles and/or pixel calculations.

In addition, embodiments of the present disclosure can apply other currently known or later developed methodologies (e.g., different sequences of mathematical operation, different methods for accounting for the inexact spherical nature of the earth, different approximation methods that may accommodate different latitudes, etc.) to calculate and/or adjust the various quantities described herein. For example, camera system 22 can produce a video feed with a 1920×1080 pixel resolution (i.e., a “Full HD” output), with each pixel in the video feed having a unique pixel coordinate. Using variables from telemetry sensor 26, such as the geospatial coordinates of AV 20 and the orientation of camera system 22, modules 124 can estimate geospatial coordinates of the video feed produced by camera system 22, e.g., latitudinal and longitudinal coordinates of the screen's leftmost, rightmost, upper, and lower boundaries. In an example embodiment, modules 124 can then calculate a geospatial coordinate corresponding to each individual pixel in the camera feed, e.g., by a linear relationship between “X,” “Y,” and/or “Z” pixel coordinates and the total difference in geospatial coordinates in environment 60 between the leftmost, rightmost, upper, and lower boundaries of the camera feed.

Telemetry sensor 26 can be operatively connected to adjustable mount 24, in embodiments where camera system 22 can be adjusted automatically and/or manually by a user, to determine attributes of camera system 22 at a particular moment in time. For example, telemetry sensor 26 can measure the roll, pitch, or yaw of AV 20 and the angular orientation of camera system 22 relative to, e.g., multiple axes. Modules 124 can then apply the coordinates from telemetry sensor 26 to the converting technique(s) described herein, and/or other formulas, look-up tables, algorithms, etc., to determine geospatial coordinates depicted within the camera feed. For example, a pixel with “X” and “Y” pixel coordinates (1, 1) can be converted into a pair of decimal coordinates, e.g., N42 39.12096 W73 45.30324, by derivation from the estimated pixel coordinates at the boundary of the camera feed. It is also understood that, in some embodiments, multiple pixels in one camera feed can share the same geospatial coordinate or coordinates. Where desired or applicable, the geospatial coordinate outputs from step S4 can then be modified, e.g., by multiplication by one or more scaling factors, to reflect possible sources of error such as a lens distortion profile of instruments in camera system 22 for generating camera feeds. Processes which correct for lens distortion are discussed in detail elsewhere herein.

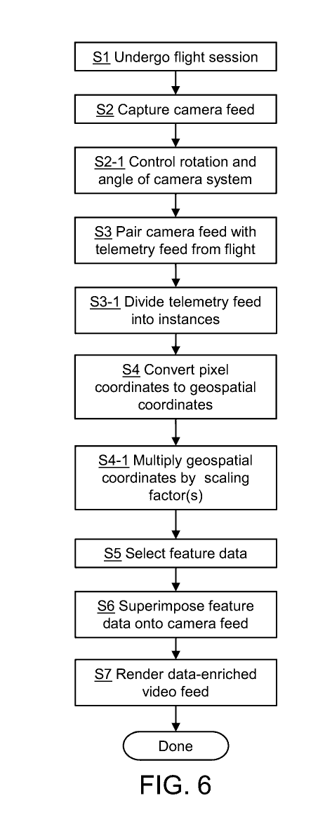

Proceeding to step S5, modules 124 of superimposition program 120 can select feature data 126 for superimposition onto one or more camera feeds. The selecting of feature data 126 in step S5 can be, e.g., automatic, user-driven through an interface, and/or provided through a combination of automatic and/or user-driven techniques. In an embodiment, modules 124 of superimposition program 120 can copy, read, or otherwise obtain one or more sets of feature data 126, which optionally can be stored within memory 112 of computing device 104. Feature data 126 can include a listing, map, or other representation of item(s) 62 within environment 60 and/or boundaries 64 between various regions or item(s) 62 in a geographic area. As discussed elsewhere herein, some items 62 and/or boundaries 64 within feature data 126 may not be fully depicted within the camera feed at a particular instance. To partially depict items 62 and/or boundaries 64 with portions missing from the camera feed, modules 124 can optionally executed steps S5-1, S5-2, S5-3, S5-4, S5-5, and/or S5-6 (FIG. 6) as described elsewhere herein. In any event, the selected feature data 126 of step S5 can include or otherwise be associated with a set of geospatial coordinates applicable for superimposition as discussed herein.

At step S6, modules 124 for combining graphical data sources can superimpose one or more sets of feature data 126 onto the camera feed(s) captured in step S2. The dimensionality of camera feed(s) captured in step S2 or feature data 126 need not limit the dimensionality of feature data 126 superimposed onto the camera feed in step S6. For example, where the camera feed(s) are captured or otherwise generated as a simulated three-dimensional environment, feature data 126 with corresponding geospatial coordinates can be mapped thereon as single points, one-dimensional lines, two-dimensional polylines, and/or three-dimensional objects. In addition or alternatively, where the camera feed(s) of step S2 include a two-dimensional representation of environment 60, feature data 126 can be superimposed thereon as three-dimensional objects, in addition to being superimposed as single points, one-dimensional lines, and/or two-dimensional polylines. It is also understood that multiple types and sets of feature data 126 can be superimposed onto multiple camera feeds simultaneously, e.g., when representing environment 60 in three dimensions. For example, where feature data 126 includes independent listings of buildings, natural landmarks, and boundaries 64, each list can be independently superimposed onto one or more camera feeds, such that a user can select which types of feature data 126 are shown or not shown. In addition or alternatively, superimposition system 120 can display multiple camera feeds from camera system 22 on a single display or I/O device 116, with some camera feeds including multiple forms of feature data 126 superimposed thereon, and other camera feeds not including any feature data 126 where applicable. In any event, the superimposition at step S6 can be provided, e.g., by generating a representation or virtual environment using camera feed(s) of step S2 and feature data 126 together on a shared coordinate system to represent environment 60 in one, two, or three dimensions.

At step S7, sequential to or simultaneous with the superimposition of step S6, superimposition program 120 can render a data-enriched video feed and/or display a data-enriched video feed. The data-enriched video feed can depict environment 60, as captured in a camera feed from camera system 22, along with graphical representations of feature data 126 superimposed thereon. The rendering in step S7 can be provided in real time during a flight session of AV 20 (e.g., step S1), such that system 10 automatically provides a data-enriched video feed to a user with no delay or negligible delay. In alternative embodiments, feature data 126 can be rendered upon an archived video feed from camera system 22 and/or other systems, or stored for later rendering and/or superimposition. An example technical effect of this process methodology can include the ability for a user to see, in real time, the position of item(s) 62 and/or boundaries 64 in geospatial data repository 50 superimposed onto camera feed(s) from camera system 22, to better understand the features of environment 60. In an example application, the user of a remote-controlled AV 20 can automatically view the position of property boundaries, locations and buildings of interest, and/or other item(s) 62 or boundaries 64 while controlling the flight of AV 20, e.g., by steps S2 through S6 being executed simultaneously with a user or system remotely controlling the flight path of AV 20 and/or position and orientation of camera system 22. It is also contemplated that the data-enriched video feed may be provided to a user through a device which controls AV 20. In yet another embodiment, feature data 126 from geospatial data repository 50 can be a real-time feed of coordinates of moving item(s) 62 or boundaries 64, such as the location of a particular vehicle or moving object. Following the rendering of process P7, the process can conclude (“done”) and may proceed in a repeating fashion (e.g., a continuous loop) where desired and/or applicable.

Referring to FIGS. 3 and 5 together, a first alternative process flow according to embodiments of the present disclosure is shown. Steps S1-S7 can proceed substantially as shown in FIG. 4 and discussed elsewhere herein, but with additional steps and decisions provided to provide additional and/or alternative functions. Specifically, the process flow of FIG. 5 illustrates sub-steps 5-1 through 5-6 relating to feature data 126 selected in step S5. At step S5-1, modules 124 with comparing functions can define items 62 or boundaries 64 from feature data 126 with at least one coordinate within camera feed(s) from camera system 22. To define items in step S5-1, modules 124 can compare whether one or more coordinates of an item 62 are contained within the geospatial coordinates yielded from step S4.

At step S5-2, modules 124 can determine whether one or more items 62 or boundaries 64 are present with the camera feed yielded from camera system 22. Where no items 62 or boundaries 64 are at least partially present within the camera feed based on the results of defining in step S5-1, i.e., “no” at step S5-2, the flow can proceed to step S6 to superimpose one or more representations of feature data 126 onto the camera feed. Where one or more items are at least partially within the camera feed, i.e., “yes” at step S5-2, the flow can proceed to steps for displaying item(s) 62 or boundaries 64 in the data-enriched video feed. At step S5-3, superimposition system 120 can pair the converted geospatial coordinates yielded from step S4 with corresponding coordinates for each item 62 and/or boundary 64 present within the camera feed. During the pairing process of step S5-3, only item(s) 62 and/or boundary(ies) 64 of feature data 126 defined in step S5-2 may be paired by modules 124 of superimposition system 120. In addition or alternatively, superimposition system 120 may perform an automatic search through feature data 126 for each item 62 with geospatial coordinates represented in the camera feed. In an embodiment where partial items 62 and/or partial boundaries 64 are not paired or considered, partial items within feature data 126 can be excluded from the pairing in step S5-3, and later incorporated through the use of phantom geospatial coordinates as discussed herein, or omitted entirely.

Proceeding from the pairing of item(s) 62 with geospatial coordinates in the camera feed, in step S5-3, the flow can proceed to step S5-4 in which modules 124 of superimposition system 120 can determine whether particular geospatial coordinates of item(s) 62 or boundary(ies) 64 are only partially represented in the camera feed. Where each item 62 or boundary 64 in the camera feed is fully represented therein (e.g., by each corresponding point having a visible corresponding geospatial coordinate in the camera feed), i.e., “no” at step S5-4, the flow can proceed to step S6 for superimposing feature data 126 onto the camera feed. Where one or more items 62 or boundaries 64 are shown only partially within the camera feed (“yes” at step S5-4), e.g., the flow can proceed to additional steps for partially displaying an item.

At step S5-5, modules 124 can calculate a set of phantom geospatial coordinates for each partially displayed item 62 or boundary 64 of the camera feed. For example, modules 124 can generate a simulated two-dimensional or three-dimensional environment depicting environment 60 before superimposing and rendering feature data 126 onto the camera feed. The simulated environment may include, e.g., item(s) 62 and/or boundaries 64 therein. Using X, Y, X, roll, pitch, yaw, and camera orientation variables from telemetry sensor 26, modules 124 can project field of vision 70 at a particular instance of time, and thereby estimate the geospatial coordinates included within field of vision 70. Where the geospatial coordinates of one or more items 62 and/or boundaries 64 appear outside field of vision 70, modules 124 can calculate or extract the geospatial coordinates of items 62 and/or boundaries 64 not specifically visible in field of vision 70. In such a situation, these coordinates can be included and/or used in other processes for rendering and/or superimposition as “phantom” geospatial coordinates. As used herein, phantom geospatial coordinates refer to geospatial coordinates rendered upon a camera feed, but not necessarily visible to a user due to being located outside the portion of environment 60 displayed within the camera feed. Phantom geospatial coordinates can aid in generating a data-enriched video feed, e.g., by rendering a line between one set of phantom coordinates and one set of ‘real’ or on-screen coordinates to thereby output a line drawn appropriately from the real coordinates in the direction of the phantom coordinates, terminating at an edge of the camera feed or field of vision 70.

After superimposition system 120 yields phantom geospatial coordinates for any partial items in step S5-5, the flow can proceed to processes for pairing the phantom geospatial coordinates with item(s) 62 partially represented in the camera feed. At step S5-6, modules 124 of superimposition system 120 can pair the calculated phantom geospatial coordinates with portions of item(s) 62 and/or boundary(ies) 64 not depicted in one or more camera feeds. In an embodiment, the pairing in step S5-6 can be used to correct or verify the position of any partially displayed items 62. For example, modules 124 can calculate and determine whether each item 62 at its paired geospatial coordinates would allow the remaining portions to be shown on the correct, paired phantom geospatial coordinates if the remaining portion of each item 62 were shown in the camera feed. In other embodiments, portions of item(s) 62 positioned outside the camera feed(s) can be displayed in a supplemental or archived illustration of environment 60. Where applicable, pairing in step S5-6 can include modifying the geospatial coordinates yielded in step S4 to reflect a true location of each item 62, before superimposing occurs in step S6 and rendering of a data enriched video feed occurs in step S7.

Referring to FIGS. 3 and 6 together, an alternative process flow according to embodiments of the present disclosure, with additional sub-steps S2-1, S3-1, and S4-1. The additional, optional sub-steps shown in FIG. 6 can be implemented together or independently of each other, and their illustration in one example process flow is solely for the purposes of example.

In combination with capturing a camera feed in step S2, embodiments of the present disclosure can include controlling a rotation and/or angle of camera system 22 in step S2-1. For example, modules 124 of superimposition system 120 with remote signaling functions can adjust a position and/or orientation of adjustable mount 24, e.g., by signaling one or more electric motors to move adjustable mount 24 and camera system 22 into a desired position. To provide these functions, adjustable mount 24 can be provided as an electric motor-driven and/or remotely adjustable mechanical assembly including, e.g., linear actuators, adjustable shafts, tracks, ball-and-socket joints, and/or any other currently known or later developed adjustable mechanical device or interconnection. Where camera system 22 includes a discrete number of cameras having individual positions and orientations on adjustable mount 24, adjusting a position and/or orientation of adjustable mount 24 can control a rotation and angle of camera system 22, during real-time operation of AV 20, to affect the camera feeds and data-enriched video feeds produced. Where applicable, telemetry sensor 26 can be operably connected to mount 24 and/or camera system 22, such that telemetry sensor 26 measures real-time data relating to the orientation, position, etc., of camera system 22 as part of a telemetry feed output. In any event, the controlling of camera system 22 and/or adjustable mount 24 in step S2-1 can adjust the angular orientation of camera system 22 and lenses thereof relative to reference axes, e.g., substantially horizontal and/or vertical axes.

Embodiments of the present disclosure can also include a sub-step S3-1 of dividing one or more telemetry feeds into individual instances, after the pairing of the camera feed with the telemetry feed in step S3. Each individual instance can include a vector representation of measurements from telemetry sensor 26 at a particular point in time, including, e.g., X, Y, and Z coordinates, roll, pitch, and/or yaw of AV 20 at a particular instance, additionally or alternatively including the position and angular orientation of camera system 22 relative to horizontal or vertical axes. Each instance within telemetry feed in step S3 can correspond to a single frame (e.g., a still image) of a camera feed produced with camera system 22. The conversion of pixel coordinates into geospatial coordinates (e.g., in step S4) discussed elsewhere herein can then be performed on each frame before the rendering data-enriched video feeds (e.g., in steps S5-S7 discussed herein).

Embodiments of the present disclosure can modify the converted geospatial coordinates, in an optional sub-step S4-1, Such modifications may reflect variances or errors caused by particular camera systems 22, components thereof, and/or factors of environment 60 which may be expressed within geospatial data repository 50. At sub-step S4-1, modules 124 of superimposition system 120 can multiply one or more of the converted geospatial coordinates by scaling factors before selecting feature data 126 in step S5, superimposing feature data 126 onto the camera feed in step S6, and rendering a data-enriched video feed in step S7.

In a first example, the memory 112 can include a static value or formula for calculating a scaling factor based on a lens distortion profile of camera system 22. The lens distortion profile of camera system 22 can be derived from the size, concavity, or other properties of lenses used for capturing the video feed. For example, where camera system 22 includes a lens with a concavity above a threshold size (e.g., a particular number of millimeters), calculator modules 124 can multiply one or more geospatial coordinates, along a particular axis or corresponding to original pixel coordinates in an outer part of the camera feed, by a scaling factor of less than one to reduce an amount of distortion within the yielded camera feed. Modules 124 can account for lens distortion using, e.g., a user-provided or automatic determination of whether the lens is a rectilinear lens, fisheye lens, and/or other type of lens. Standard manufactured lenses with low variability in distortion between each manufactured lens can have their distortion profile mathematically modeled using a set of “lens distortion parameters” that define each lens. These lens distortion parameters can include, e.g., the horizontal focal length, the vertical focal length, the field of view, one or more radial distortion parameters, the image center X coordinate, the image center Y coordinate, etc., and/or any currently known or later developed parameter for detailing the properties of a field of view.

Various mathematical computations can account for the effect of lens distortion (horizontal and/or vertical shifts in pixel representation) based on one or more lens distortion parameters for any given point on the image. In addition, for lenses that are irregular, or for which the exact lens distortion parameters are not known or are not reliable, effect on lens distortion can be determined iteratively or experimentally, e.g., using a collection of data for the lens. For example, lens distortion could be determined experimentally using a grid of values, which can then be referenced when calculating the location of any geospatial coordinate in pixel space. These methods are provided as illustrative example, and other processes (mathematical and otherwise) can also be applied to determine or calculate a lens distortion profile for rectilinear lenses, fisheye lenses, and/or any other currently known or later-developed type of lens.

In another embodiment, the scaling factor can be provided as a static value or formula output based on a focal length or radial distortion of the lens of camera system 22. A focal length can generally refer to a range of distances from item(s) 62 in environment 60 at which the output of camera system 22 is “in focus,” a scaling factor may be applicable where AV 20 is located outside this range of distances during a flight session, and therefore may include distortions and/or errors in the camera feed yielded during a flight session. Similarly, “lens distortion” can refer to an effect in particular lenses where features with straight lines, appearing near the edges of a lens, seemingly have a curvature. Here, modules 124 can apply a scaling factor of greater or less than one to geospatial coordinates in a distortion region to smooth the depiction of item(s) 62 and/or boundaries 64 in a perimeter area of the camera feed.

In a third example, modules 124 can additionally or alternatively apply a scaling factor to calculated geospatial coordinates yielded from step S4 based on surface topologies 80 (FIG. 1) represented in the camera feed of camera system 22. For example, geospatial data repository 50 and/or feature data 126 may include a particular surface topology 80. Some surface topologies 80, e.g., peaks and valleys, may skew the conversion of pixel coordinates into geospatial coordinates in the event that no corrections occur. To compensate for this situation, modules 124 can multiply the converted geospatial coordinates by scaling factors of less than one or more than one in regions where a surface topology 80 can skew the conversion from pixel coordinates to geospatial coordinates. Example processes for modifying pixel and/or geospatial coordinates based on surface topology 80 are described in further detail elsewhere herein. It is understood that the various scaling factors described herein can be applied as alternatives, or in addition to each other.

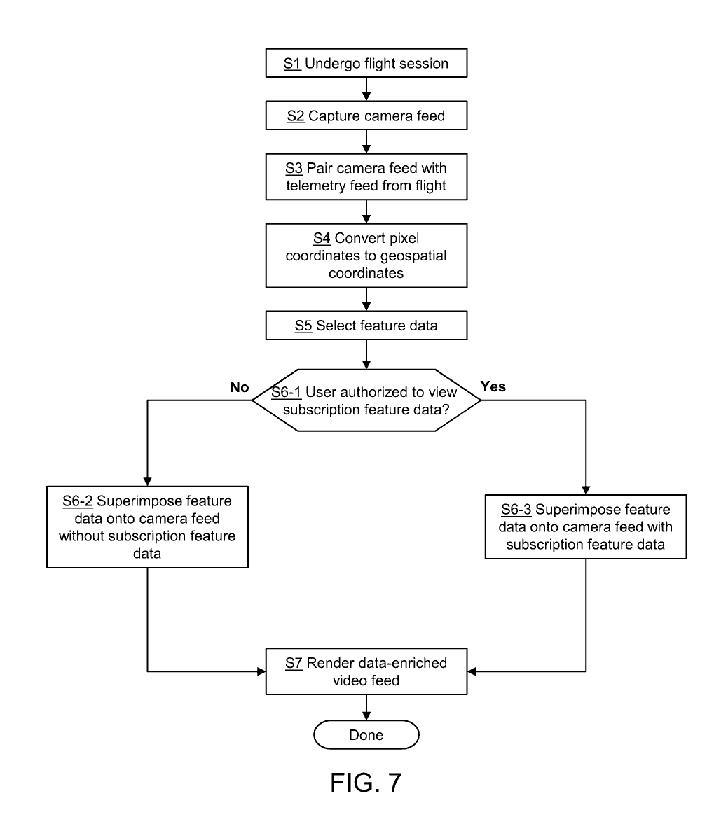

Referring now to FIGS. 3 and 7, embodiments of the present disclosure can also include processes for controlling access to certain types of feature data 126 within geospatial data repository 50. It is understood that system 10 can feature a subscription model for expanding and/or limiting access to various types of feature data 126 by particular users. To provide this effect, embodiments of the present disclosure can include sub-steps S6-1, S6-2, and S6-3 after the selecting of feature data in step S5, as a replacement for embodiments of step S6 discussed elsewhere herein. At step S6-1, modules 124 can determine (e.g., based on user profile(s) 128) whether a particular user is cleared to access feature data 126 or particular vectors therein. In an embodiment, the determination at step S6-1 can be based on whether user profile(s) 128 include corresponding access key(s) 130 which designate whether a given user is permitted to access certain types of feature data 126. Where user profile 128 does not include access for a particular set of feature data 126 or information therein, the flow can proceed to a step S6-2 in which superimposition system 120 omits the excluded feature data 126 from superposition onto the camera feed. Optionally, superimposition system 120 can notify the user of denied access and/or offer purchase or subscription options to the user for the excluded data. Where modules 124 determine that a user profile 128 includes access to particular feature data 126, the flow can proceed to step S6-3, in which additional feature data 126 is superimposed onto the camera feed. Where user profile 128 includes access keys 130 for some types of feature data 126 but not others, it is understood that sub-steps S6-2 and S6-3 can be executed simultaneously for various forms of feature data 126. In any event, the flow can then proceed to step S7 for rendering a data-enriched video feed for only the forms of feature data 126 available to a user based on user profile 128.

The present disclosure may be embodied as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, Java, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or” comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for generating a data-enriched video feed, the method comprising:
pairing a camera feed of an aerial vehicle (AV) from a flight session with a telemetry feed of the AV from the flight session;
converting a set of pixel coordinates within the camera feed into a first set of geospatial coordinates using the telemetry feed of the AV from the flight session; and
rendering a data-enriched video feed including the at least one set of feature data, including a corresponding second set of geospatial coordinates, superimposed onto the first set of geospatial coordinates within the camera feed.

2. The method of claim 1, further comprising:
identifying at least one partial item within the camera feed, wherein the at least one partial item includes a missing portion absent from the camera feed;
calculating a set of phantom geospatial coordinates for the missing portion of the at least one partial item; and
pairing the set of phantom geospatial coordinates for the missing portion of the at least one partial item with the second set of geospatial coordinates, before the rendering of the data-enriched video feed.

3. The method of claim 2, further comprising defining a plurality of items from the at least one set of feature data and at least partially within the camera feed, before the identifying of the at least one partial item.

4. The method of claim 1, wherein the camera feed is captured using a camera system independent from the AV.

5. The method of claim 1, further comprising displaying the data-enriched video feed during the flight session, in real-time.

6. The method of claim 1, wherein the feature data is included within a one of a third-party database and a user proprietary database.

7. The method of claim 1, further comprising controlling a rotation and an angle of a camera system, operatively connected to the AV, in real-time during capturing of the camera feed and the rendering.

8. The method of claim 1, wherein the telemetry feed includes real-time values of an x-coordinate, a y-coordinate, and a z-component of the AV.

9. The method of claim 1, wherein the telemetry feed includes real-time values of a pitch, a roll, a yaw, and an angle relative to a horizontal axis, and an angle relative to a vertical axis of a camera system of the AV.

10. The method of claim 1, further comprising:
identifying at least one item within the camera feed;
pairing a point within the camera feed, having a position within the first set of geospatial coordinates, with the at least one item; and
superimposing a representation of the item, with the at least one set of feature data, onto the first set of geospatial coordinates within the camera feed.

11. The method of claim 10, wherein the at least one item comprises one of a zero-dimensional point, a one-dimensional line, a two-dimensional polygon, and a three-dimensional simulated object.

12. The method of claim 1, further comprising defining a plurality of items within the camera feed, before the identifying.

13. A system for generating a data-enriched video feed with an aerial vehicle (AV) the system comprising:
a camera for capturing a camera feed;
an adjustable mount operatively coupling the camera to the AV and configured to adjust an angle of the camera relative to a horizontal axis, and an angle of the camera relative to a vertical axis;
a telemetry sensor operatively coupled with the AV for generating a telemetry feed including an x-coordinate, a y-coordinate, and a z-component of the AV; and
a computing device in communication with a geospatial data repository having at least one set of feature data provided therein, wherein the computing device is configured to:
pair the camera feed of the aerial vehicle (AV) from a flight session with the telemetry feed of the AV from the flight session;
convert a set of pixel coordinates within the camera feed into a first set of geospatial coordinates using the telemetry feed of the AV from the flight session;
render a data-enriched video feed including the at least one set of feature data, including a corresponding second set of geospatial coordinates, superimposed onto the first set of geospatial coordinates within the camera feed.

14. The system of claim 13, further comprising a display operatively connected to the computing device and configured to display the data-enriched video feed during the flight session, in real-time.

15. The system of claim 13, wherein the geospatial data repository includes one of a third-party database and a user proprietary database.

16. The system of claim 13, wherein the adjustable mount is controllable in real-time during capture of the camera feed.

17. The system of claim 13, wherein the telemetry feed includes real-time values of a pitch, a roll, a yaw, and an angle relative to a horizontal axis, and an angle relative to a vertical axis of a camera system of the AV.

18. The system of claim 13, wherein the computing device is further configured to:
identify at least one item within the camera feed;
pair a point within the camera feed, having a position within the first set of geospatial coordinates, with the at least one item; and
superimpose a representation of the item, with the at least one set of feature data, onto the first set of geospatial coordinates within the camera feed.

19. The system of claim 18, wherein the at least one item comprises one of a zero-dimensional point, a one-dimensional line, a two-dimensional polygon, and a three-dimensional simulated object.

20. The system of claim 13, wherein the computing device is further configured to define a plurality of items within the camera feed.

21. A program product stored on a computer readable storage medium, the program product operable to generate a data-enriched video feed when executed, the computer readable storage medium comprising program code for:
pairing a camera feed of an aerial vehicle (AV) from a flight session with a telemetry feed of the AV from the flight session;
converting a set of pixel coordinates within the camera feed into a first set of geospatial coordinates using the telemetry feed of the AV from the flight session;
rendering a data-enriched video feed including the at least one set of feature data, including a corresponding second set of geospatial coordinates, superimposed onto the first set of geospatial coordinates within the camera feed.

22. The program product of claim 21, wherein the camera feed is captured using a camera system independent from the AV.

23. The program product of claim 21, further comprising program code for displaying the data-enriched video feed during the flight session, in real-time.

24. The program product of claim 21, wherein the feature data is provided within one of a third-party database and a user proprietary database.

25. The program product of claim 21, further comprising program code for controlling a rotation and an angle of a camera system, operatively connected to the AV, in real-time during capturing of the camera feed and the rendering.

26. The program product of claim 21, wherein the telemetry feed includes real-time values of an X-coordinate, a Y-coordinate, and a Z-coordinate of the AV.

27. The program product of claim 21, wherein the telemetry feed includes real-time values of a pitch, a roll, a yaw, and an angle relative to a horizontal axis, and an angle relative to a vertical axis of a camera system of the AV.

28. The program product of claim 21, further comprising program code for:
identifying at least one item within the camera feed;
pairing a point within the camera feed, having a position within the first set of geospatial coordinates, with the at least one item; and
superimposing a representation of the item, with the at least one set of feature data, onto the first set of geospatial coordinates within the camera feed.

29. The program product of claim 28, wherein the item comprises one of a zero-dimensional point, a one-dimensional line, a two-dimensional polygon, and a three-dimensional simulated object.

30. The program product of claim 28, further comprising program code for defining a plurality of items within the camera feed, before the identifying.

31. The program product of claim 28, further comprising program code for defining a plurality of items from the at least one set of feature data and at least partially within the camera feed, before the identifying.
